(19) United States
(12) Patent Application Publication
(10) Pub. No.: US 2005/0113487 A1
(43) Pub. Date: May 26, 2005

(54) Masterbatch precursor

(75) Inventors: Charles J. Willard, Peekskill, NY (US); Stephane Rochard, Chavenay (FR); Michael J. Venturini, Yorktown Heights, NY (US); Doreen C. Becker, Pleasantville, NY (US); Shahjahan Kazi, Kendall Park, NJ (US)

Correspondence Address: ENGELHARD CORPORATION, 101 WOOD AVENUE, ISELIN, NJ, 08830, US

(73) Assignee: ENGELHARD CORPORATION

(21) Appl. No.: 10/995,756

(22) Filed: Nov. 23, 2004

Related U.S. Application Data
(60) Provisional application No. 60/524,795, filed on Nov. 25, 2003.

(51) Int. Cl. C04B 2/00; C09D 5/29

(52) U.S. Cl. 523/171; 106/502; 106/415

(57) ABSTRACT

The present invention provides a substantially spherical composition comprising about 60 to 80 percent by weight peariescent pigment, 14 to about 38 percent by weight wax, and about 2 percent to 6 percent surfactant. This composition is particularly useful for extrusion into any polymer used for masterbatching. The masterbatch is then typically blow or injection molded or extruded into a finished part.

### BACKGROUND OF THE INVENTION

Pearlescent or nacreous pigments simulate the effect of natural pearl and are composed of thin platelets which are transparent in the visible region of the spectrum. The platelets are very smooth and part of the light which strikes the platelets is reflected and part of the light is transmitted through the platelets. That part of the light that is transmitted is subsequently reflected by other layers of platelets. The result is that multiple reflections from many layers occur and this results in depth of sheen since the eye cannot focus on one particular layer.

The reflection that occurs is specular in that the angle of incidence equals the angle of reflection. The amount of light reflected at non-specular angles is small and the amount of light reflected diminishes very quickly as the specular angle is passed. The result is that pearlescent pigments are extremely sensitive to viewing angle. In order for the maximum amount of light to be reflected, the platelets must be extremely smooth. Any surface roughness causes light to be scattered in a non-specular manner and diminishes the lustrous effect.

The platelets must be aligned parallel to each other and to the substrate for maximum reflectivity. If not so aligned, light will be reflected randomly and again, luster will diminish. The amount of light that is reflected depends on the index of refraction. As the index of refraction increases, the amount of reflected light increases.

The Mearl Corporation's Use of Mearlin Luster Pigments in Plastics publication dated Oct. 1979 teaches that pearlescent pigments composed of mica coated with titanium dioxide and/or iron oxide can be dispersed with polyolefins. The reference recommends adding 1% of a low molecular weight polyethylene powder for best dispersion. The incorporation of the pearlescent pigments into concentrate form may be accomplished by pre-mixing in a Banbury type or continuous mixer. In addition to Banbury mixers and continuous mixer-extruders, other types of mixers such as 2-roll mills, calendars, vortical intensive mixers (Henschel type) and double planetary mixers may be used to make concentrates. See also commonly assigned U.S. Pat. No. 3,819,566.

The concentrate is typically combined with organic colorant and polymer and then extruded and pelletized to form a masterbatch. The masterbatch is then typically blow or injection molded to form finished parts.

U.S. Pat. No. 6,451,102 teaches that an embedded pigment is one that is surrounded by or coated at least partially with a material that improves its flow characteristics. The reference teaches that an embedded pigment is useful in masterbatch production and one useful embedded pigment is commercially available IRIODIN® WM8 pigment. Merck's Effect Pigments for Plastics dated 0303 (available in Oct. 2003 on Merck's website) teaches that IRIODIN® WM8 pigment comprises 70% pearl luster pigment (titanium dioxide coated mica) and 30% of a low level molecular polymer. When we extruded Merck's IRIODIN® WM8 pigment using Comparative A masterbatch precursor below to form Comparative F masterbatch below, we found that the extruder strand broke and thus, manual feed from the extruder to the pelletizer was required. Also, the product of Comparative A is disadvantageously not substantially spherical.

U.S. Pat. No. 6,398,862 teaches a non-dusting composition. The patent teaches that the paste is extruded or compacted into granules and thus, does not explicitly or inherently teach a substantially spherical composition.

Thus, the industry needs a masterbatch precursor that does not result in broken strands. A masterbatch precursor providing higher extruder throughput is also desired.

### SUMMARY OF THE INVENTION

Responding to the need in the industry, the present invention provides a substantially spherical composition comprising about 60 to about 80 percent by weight pearlescent pigment, about 14 to about 38 percent by weight wax, and about 2 to about 6 percent by weight surfactant. The substantially spherical shape of the present invention results in improved flowability. The present invention also provides a masterbatch precursor comprising the preceding composition. The present invention also provides a method of increasing masterbatch throughput in an extruder comprising the steps of: combining a polymer and substantially spherical composition comprising pearlescent pigment, wax, and surfactant, and extruding the combination to form a masterbatch.

Advantageously, the present composition is non-dusting, provides increased masterbatch extruder throughput, minimizes or eliminates strand breakage from the extruder, and reduces production time.

### BRIEF DESCRIPTION OF THE DRAWINGS

FIG. 1 is a GCMS of Comparative A.

FIG. 2 is a DSC of Comparative A, Inventive Example 3, and Inventive Example 4.

FIG. 3 is a GCMS of Inventive Example 1.

FIG. 4 is optical microscopy of the Comparative A product.

FIG. 5 is optical microscopy of a masterbatch precursor similar to that of Inventive Example 1.

### DETAILED DESCRIPTION OF THE INVENTION

Pearlescent Pigment:

The phrase “pearlescent pigment” as used herein means pigment that exhibits pearl-like or nacreous or iridescent effects upon the transmission and reflection of light therethrough or therefrom. As is well known in the art, the characteristics of such pigment depend upon optical interference phenomena as more fully described in L. M. Greenstein, “Nacreous (Pearlescent) Pigments and Interference Pigments”, Pigment Handbook, Volume 1, Properties and Economics, Second Edition, John Wiley & Sons, Inc. (1988).

Pearlescent pigments useful in the present invention include titanium dioxide coated mica; iron oxide coated mica; iron oxide coated titanium dioxide coated mica as disclosed in commonly assigned U.S. Pat. No. 4,146,403 to Louis Armanini et al.; iron oxide or titanium dioxide coated glass as disclosed in commonly assigned U.S. Pat. No. 5,753,371 to William J. Sullivan et al.; platy metal oxides as disclosed in commonly assigned U.S. Pat. No. 5,611,851 to Carmine DeLuca et al.; bismuth oxychloride effect pigments as disclosed in commonly assigned U.S. Pat. Nos. 6,572,695, 6,579,357, and 6,582,507 to Paul Cao; optically variable pigments as disclosed in commonly assigned U.S. Pat. Nos. 6,325,847 and 6,440,208 to James D. Christie et al.; the dielectric reflectors of U.S. Pat. No. 6,132,873; substrates coated with silicon dioxide and then iron oxide or titanium dioxide; and substrates coated with titanium dioxide or iron oxide and then silicon dioxide; all incorporated herein in their entireties; FIREMIST® pearlescent pigments (comprise calcium sodium borosilicate and titanium dioxide) commercially available from Engelhard Corporation; MAGNAPEARL® 1000 pearlescent pigment (comprises 70-80 weight percent mica and 20-30 weight percent titanium dioxide) commercially available from Engelhard Corporation; MAGNAPEARL® 1100 pearlescent pigment (comprises 67-75 weight percent mica, 0.2-2.0 weight percent tin oxide, and 25-31 weight percent titanium dioxide) commercially available from Engelhard Corporation; MAGNAPEARL® 2100 pearlescent pigment (comprises 56.5-64.5 weight percent mica, 0.2-2.0 weight percent tin oxide, and 35.5-41.5 weight percent titanium dioxide) commercially available from Engelhard Corporation; and platy titanium dioxide commercially available from Engelhard Corporation.

Useful pearlescent pigments include at least one metal oxide coating on a blend of at least two different materials or substrates that have any morphology including platelet, spherical, cubical, acicular, whiskers; or fibrous. Examples of useful platy materials include platy aluminum oxide, platy glass, aluminum, mica, bismuth oxychloride, platy iron oxide, platy graphite, platy silica, bronze, stainless steel, natural pearl, boron nitride, silicon dioxide, copper flake, copper alloy flake, zinc flake, zinc alloy flake, zinc oxide, enamel, china clay, and porcelain and the like. Any combination of the preceding platy materials or at least one of the preceding platy materials and at least one non-platy material may be used. For convenience, the following description will focus on the combination of glass and mica, although other combinations can be used. Mica is desirable because of its high transparency, strong reflectance and strong chroma, primarily due to the presence of small, coated flakes. Glass flakes have the attributes of high transparency, very white bulk color and a sparkle effect in strong light but, as noted above, its high cost and melting point preclude its use in many applications.

Examples of useful spherical materials include glass, plastic, ceramic, metal, or an alloy and the spheres may be solid or hollow. Useful glass spheres are disclosed in U.S. Pat. No. 5,217,928, incorporated in its entirety herein by reference.

Useful cubical material includes glass cubes. In one example, the present invention uses a blend of two or more laminar substrates. Preferably, one of the substrates is either platy aluminum oxide or platy glass.

Individually, each substrate may constitute about 5 to 90% of the mixture although it is preferred that the majority of the blend is constituted by one substrate, e.g., mica. More preferably, the blend contains at least about 65% mica and even more preferably at least about 75% mica. Individually, the mica platelets and glass platelets have an average particle size and thickness in the ranges specified above. While it is preferable to employ C glass, as in the prior art, any type of glass and morphology can be used in the present invention. Other useful glass flakes have a thickness of ≦1.0 μm and a softening point ≧800° C.

Glass can be classified for example as A glass, C glass, E glass, and ECR glass. Glass types which fulfill the feature of the requested softening point are quartz glass, and any other glass composition having a softening point of >800° C. Glass flakes which fulfill the requirements are special glasses like e.g. Schott Duran or Supremax types. The softening point is defined, according to ASTM C 338 as the temperature at which a uniform fiber of glass with a diameter of 0.55-0.75 mm and a length of 23.5 cm increases its length by 1 mm./min when the upper 10 cm. is heated at a rate of 5° C./min.

Examples of useful mixtures of at least two different materials or substrates are in the following table:

| FIRST MATERIAL | SECOND MATERIAL |
|---|---|
| A Glass | C Glass |
| A Glass | E Glass |
| A Glass | ECR Glass |
| A Glass | Quartz Glass |
| C Glass | E Glass |
| C Glass | ECR Glass |
| C Glass | Quartz Glass |
| E Glass | ECR Glass |
| E Glass | Quartz Glass |
| Silicon carbide | Mica |
| Glass spheres | Mica |
| Predominantly iron oxide | Glass spheres |
| containing other oxides | |
| Predominantly iron oxide | Mica |
| containing other oxides | |
| Zinc oxide | Glass |
| Metal or alloy | Glass |
| Ceramic microspheres | Mica |
| Glass bubbles | Mica |

Wax:

The wax of the present invention improves the flowability of the pearlescent pigment. Preferably, the wax comprises polar groups and dispersive groups with the overall character of the wax being more dispersive than polar. Preferred polar groups include functional groups that contain oxygen, amine, or acid. Preferred dispersive groups include linear or branched hydrocarbons, saturated or unsaturated hydrocarbons, and halogenated hydrocarbons. The dispersive groups contain sigma bonds that allow rotation and thus facilitate the polar group's electrostatic attraction to the pearlescent pigment; they also have affinity to the polymer. The wax is preferably an oxidized hydrocarbon, more preferably an oxidized saturated hydrocarbon, even more preferably oxidized polyolefin, and most preferably oxidized polyethylene. Preferably, the melting point of the wax is lower than that of the polymer in which it is incorporated in order to take advantage of is the increased masterbatch throughput rate afforded by an earlier melting mixture. Useful oxygenated polyolefin waxes include polyethylene and polypropylene. The wax is present at preferably 14 to about 38 weight percent in the composition, more preferably about 18 to about 32 weight percent in the composition, and most preferably about 25.8 to about 26.5 weight percent in the composition.

Surfactant:

Preferably, the present surfactant has polar and non-polar dispersive portions. In the surfactant, the polar portion comprises ethoxylated alcohol while the non-polar dispersive portion comprises hydrocarbon. In the surfactant, the polar portion attaches to the polar titania surface of the preferred pearlescent pigment. In the surfactant, the non-polar dispersive portion allows the facile dispersion of the surfactant into the preferred polyolefin and because the pearlescent pigment's polar portion is attached to the surfactant's polar portion, the surfactant allows easier mixing into the preferred polyolefin. The molecular weight (Mn) of the surfactant ranges from about 800 to about 1300. The most preferred surfactants include poly(oxy-1,2-ethanediyl),α-(9Z)-9-octadecenyl-ω-hydroxy-(9Cl) and a mixture of C12-14 secondary ethoxylated alcohols. Thus, advantageously, the surfactant of the present invention functions to provide additional wetting of the pearlescent pigment and lowers the energy required to mix the masterbatch precursor and polymer. The surfactant is present at preferably about 2 to 6 percent by weight of the composition, more preferably about 3 to about 4.5 percent by weight of the composition, and most preferably about 3.5 to about 4.2 percent by weight of the composition. Advantageously, the mixture of C12-14 secondary ethoxylated alcohols is approved by the FDA for food contact use. Sakai, Tadao; Simultaneous Determination of Cationic Surfactants and Nonionic Surfactants by Ion Association Titration; Analytical Sciences; Sep. 2003; v 19; pp 13223-25 provides a useful titration procedure.

The phrase “substantially spherical” as used herein means that at least 50 percent of the composition has a spherical shape when viewed under an optical microscope.

We have discovered that the use of a wax emulsion comprising a mixture of wax, surfactant, and water is critical in the present invention. In this wax emulsion, the surfactant lowers the energy required to mix the two immiscible components, i.e., the wax and water, and also functions to stabilize the emulsion. A preferred emulsion has an average particle size of less than one micron. Emulsions of oxidized polyolefin wax and surfactant are available as MICHEM®72040, 72040M, and 72040M1 emulsions from Michelman. Michelman's MICHEM® 72040M1 emulsion has 60 weight percent water, 35 weight percent wax, and 5 weight percent surfactant. Michelman product brochure dated 2002 teaches that MICHEM® emulsion 72040 is a nonionic polyethylene wax that is useful in the textile industry to improve lubricity during processing, and most commonly as a needle lubricant, reducing needle wear in high-speed sewing operations but does not teach or suggest its use in the present invention.

Preparation:

The emulsion and pigment are combined in a low shear mixing vat. Preferably, the weight ratio of emulsion to pigment is about 1.8 to about 1 and more preferably about 1.068 to about 1.

The emulsion and pigment are mixed and then deionized water is added to obtain the desired viscosity. Mixing occurs in a vessel under continuous and slow stirring. The mixing rate should produce a relatively low shear so that the entrainment of air into the slurry is minimal.

The mixture should be processed through a spray drier as quickly as possible. Otherwise, holding in the mixing vessel or a tank may lead to components segregating or settling. The mixture is pumped into the spray drier through an atomization device. A rotary wheel atomizer or other droplet formation system may be used. This mixture is then fed into a spray drier while maintaining the inlet temperature between about 200° C. to about 360° C. (equals about 392° F. to about 680° F.) and outlet temperature between about 88° C. to about 115° C. (equals about 190° F. to about 240° F.). The spray drier outlet temperature is slightly higher than the wax temperature so that the wax flows around the pearlescent pigment.

The resulting substantially spherical composition provides desirable product flow characteristics such as lower shear resistance during flow with the polymer through the extruder barrel. Extruder throughput capacity is also improved. The resulting dry mixture contains about 70% pearl.

Although not wishing to be bound by theory, we believe that the surfactant lowers the energy required for the extruder mixing phase to mix the polymer and masterbatch precursor and thus, leaves more energy available for the extruder pumping phase and that the surfactant accomplishes the preceding by at least partially encapsulating the pearlescent pigment.

The present composition is particularly useful in any process wherein pearlescent pigments are processed at temperatures greater than 120° C. and incorporated into a polymer. The present composition may be extruded into any polymer used for masterbatching. Useful amorphous polymers include polystyrene, styrene maleic anhydride, acrylonitrile butadiene styrene, polyvinyl chloride, polymethyl methacrylate, styrene acrylic nitrile, polycarbonate, polyphenyloxide, polyarylate, polysulfone, polyethersulfone, polyetherimide, polyphenylene sulfide, and polyamide-imides. Useful crystalline resins include polyolefins including low density and high density polyethylene, ultra high molecular weight polyethylene, and polypropylene; polyoxymethylene; nylons including nylon 6, nylon 6/6, and nylon 4/6; polyesters including polyethylene terephthalate and polybutylene terephthalate, polyphthalamide, fluoropolymer, and polyether etherketone.

The present composition is advantageously used in polymer masterbatch formulations in an amount sufficient to prepare a masterbatch of at least about 25 weight percent pearlescent pigment based on the total composition. In particular, the present masterbatch precursor is incorporated into a masterbatch polymer in an amount sufficient to prepare a masterbatch of at least about 35 weight percent pearlescent pigment based on the total composition.

Utility:

A masterbatch is typically letdown into a compatible virgin polymer to prepare a finished pigmented part by blow molding, injection molding, or extrusion processing. Examples include cosmetics and personal care product containers such as skin care products including facial masks, UV protective lotions, liquid soaps, baby oil, and antimicrobial products; hair care products including shampoo, conditioner, spray or fixative, and colorant; makeup products including nail polish, mascara, eye shadow, and perfume; shaving cream; deodorant; dental products; laundry detergent bottles; food and beverage containers; toys; combs; pharmaceutical packaging films; and food packaging films.

Analytical Test Methods:

Melting point was determined by Differential Scanning Calorimetry (DSC) and Thermal Gravimetric Analysis (TGA). For the DSC, an aluminum sample pan commercially available from Perkin-Elmer was used. A sample weighing 2.2-2.4 milligrams was placed into the pan. A lid was placed onto the pan and the lid was then crimped. Perkin-Elmer DSC7 Compensation Type was used. Nitrogen at 25 milliliters/minute was used. The sample was heated from ambient to 200° C. at 10° C./minute at one second intervals.

For the TGA, a macro platinum sample pan commercially available from Perkin-Elmer was used. A sample weighing 4.4-4.5 milligrams was placed into the pan. A Shimadzu TGA50 was used. Nitrogen at 30 milliliters/minute was used. The sample was heated from ambient to 300° C. at 20° C./minute at two-second intervals.

Gas Chromatography Mass Spectroscopy was determined as follows. The sample was placed in a Thermex™ pyrocell and heated to 230° C. at a rate of 10°/min in flowing helium and held at 230° C. for 10 min. The effluent off-gases were trapped in a cryocell at approximately 150° C. Subsequent to the pyrolysis heating cycle, the temperature of the cryocell was stepped to 300° C., releasing the trapped analytes into the GC column (Varian CP-Sil 5 CB general purpose column, 30 m×0.32 mm×10 m). The GC (HP6890) oven was then heated from room temperature to 290° C. at a rate of 10°/min. Mass spectra were collected by a LECO Pegasus II TOF-MS unit throughout the entire duration of the GC oven heating cycle. All masses between 5 and 300 were monitored simultaneously at an acquisition rate of 20 spectra per second.

Ashing or loss on ignition was determined as follows. 1-2 grams of sample were placed into a porcelain crucible and then placed into a furnace set at 900° C. After one hour, the sample was removed from the furnace to a dessicator and cooled to room temperature. The crucible with the sample was weighed. The loss on ignition (LOI) was calculated as follows: % LOI=crucible weight+((W₂−Wₑ)/(W₁−Wₑ))×100 where W₂ crucible weight+sample after ignition (in grams), W₁=crucible weight+sample before ignition (in grams), and Wₑ=crucible weight empty after ignition (in grams).

The following Comparatives and Inventive Examples are directed to masterbatch precursors and preparation thereof.

### COMPARATIVE A

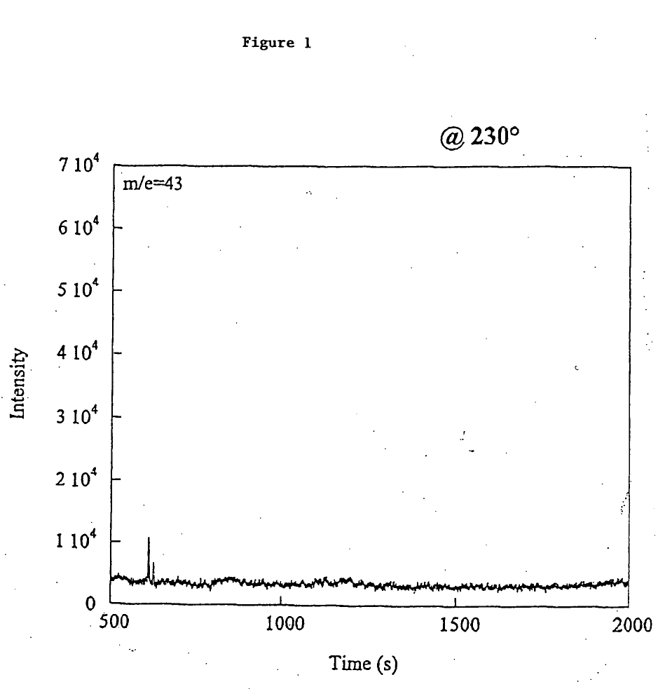

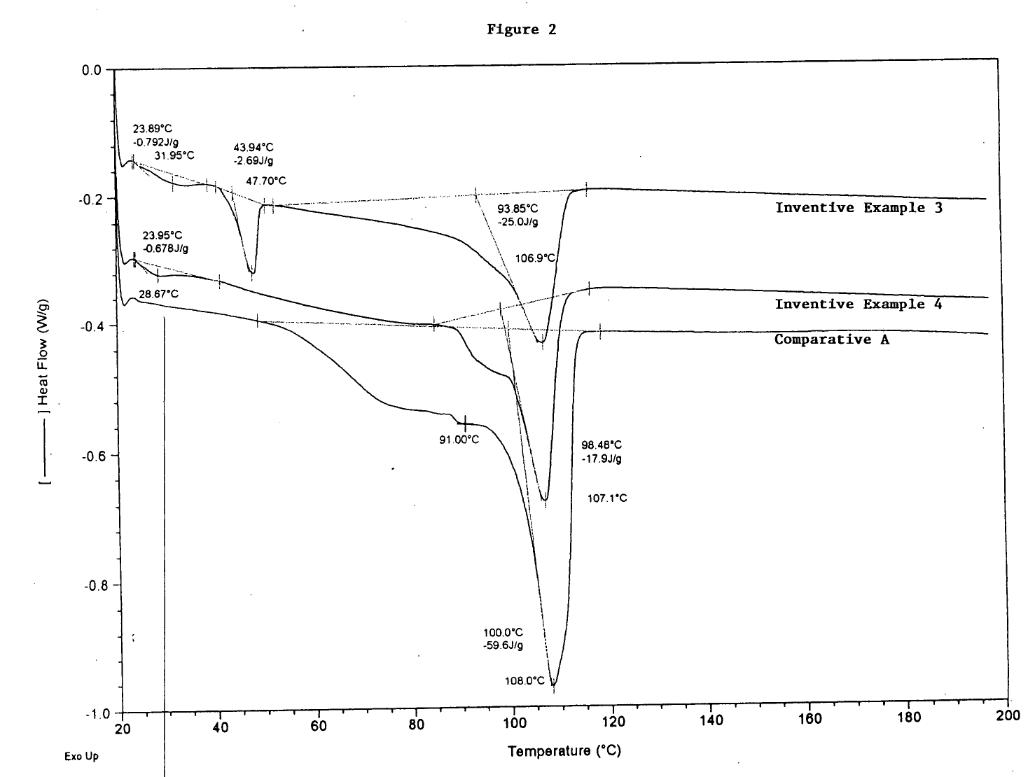

Comparative A was Merck's IRIODIN®μWM8 pearlescent pigment. Merck's Effect Pigments for Plastics dated 0303 (available in Oct. 2003 on Merck's website) teaches that IRIODIN® WM8 pigment comprises 70% pearl luster pigment (titanium dioxide coated mica) and 30% of a low level molecular polymer. A GCMS of Comparative A is shown in FIG. 1. The results show the presence of hydrocarbon groups. Since surfactant typically has polar groups and Comparative A did not show the presence of any polar groups such as —NH₂, —COOH, —COC—, or —COH, Comparative A does not contain surfactant. A DSC of Comparative A is shown in FIG. 2.

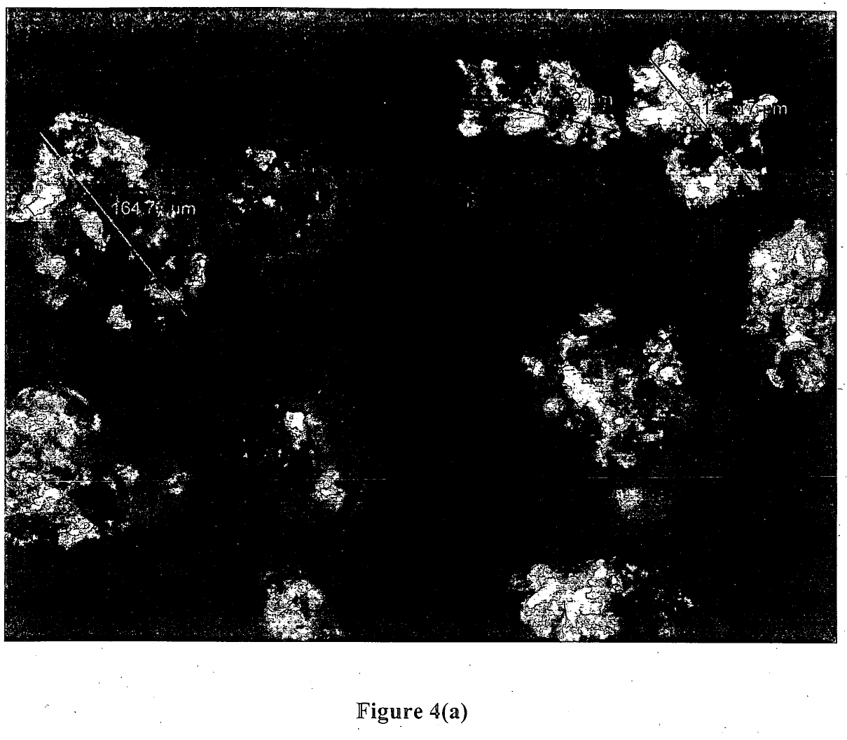

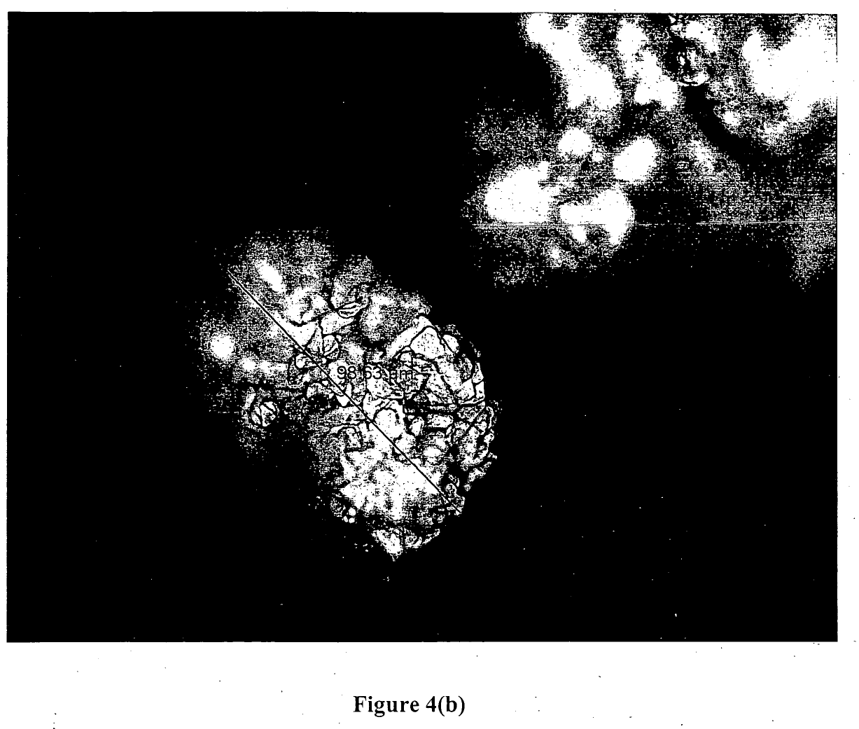

The product was subjected to optical microscopy. Optical microscopy revealed that almost all of the resulting product was not spherical as shown in FIG. 4(a) at 200× magnification and FIG. 4(b) at 500× magnification; instead, the material is in the form of agglomerated clumps. The average particle size diameter was about 10 to about 180 microns with most particles having an average particle size diameter from about 20 to about 120 microns.

### COMPARATIVE B

Comparative B comprised 35 percent by weight low density polyethylene (having a melting point of 160° C.; supplied by Union Carbide Corporation) and 65 percent by weight pigment (MAGNAPEARLO® 2100 pigment from Engelhard Corporation) and was made as follows. No surfactant was present.

525 grams of the low density polyethylene and 975 grams of the pigment were added to a 3.5 pound capacity Banbury mixer. Mixing continued for 14 minutes at 300° F. to 368° F. (about 149° C. to about 187° C.). The composite was discharged, cooled to room temperature, chopped into approximately one inch cubes, and then ground to particles not exceeding 4 millimeters in diameter in a rotating knife-type granulator.

### COMPARATIVE C

Comparative C comprised 35 percent by weight ethylene-acrylic acid copolymer wax (A-C® 5120 from Honeywell Inc.) and 65 percent by weight pigment (MA GNAPEARL® 2100 pigment from Engelhard Corporation) and was made as follows. No surfactant was present.

525 grams of the ethylene-acrylic acid copolymer and 975 grams of the pigment were added to a 3.5 pound capacity Banbury mixer. Mixing continued for 11 minutes at 190° F. to 222° F. (about 88° C. to about 106° C.).

The mixture was of a crumbly consistency and did not require chopping prior to being granulated. The granulator described in Comparative B was used, but only 1000 grams of granulated product was obtained before the 4 millimeter holes became plugged with semi-solid wax, the melting point of which at 92° C. is sufficiently low to begin melting from the frictional heating of the equipment.

### COMPARATIVE D

Comparative D comprised 35 percent by weight polyethylene wax (A-C® 725 homopolymer from Honeywell Inc.) and 65 percent by weight pigment (MAGNAPEARL® 2100 pigment from Engelhard Corporation) and was made as follows. No surfactant was present.

525 grams of the polyethylene wax and 975 grams of the pigment were added to a 3.5 pound capacity Banbury mixer set at 250° F. (about 121° C.) and allowed to completely melt at 100 RPM. The final batch was stirred for nine minutes. The wax melting point was 110C. The mixture was of a crumbly consistency and did not require chopping prior to being granulated. The product was then granulated in a rotating knife-type granulator and ground to a free-flowing dust-free powder.

### INVENTIVE EXAMPLE 1

Into a plastic bucket was added a mixture of 700 grams of pigment, 750 grams of 40% solids emulsion, and 1883 grams of distilled water. The pigment used was MAGNAPEARL® 2100 pigment from Engelhard Corporation and comprised 56.5-64.5 weight percent mica, 0.2-2.0 weight percent tin oxide, and 35.5-41.5 weight percent titanium dioxide. The emulsion comprised about 96.3 percent by weight oxidized polyethylene wax and 3.7 percent by weight poly(oxy-1,2-ethanediyl),α-(9Z)-9-octadecenyl-ω-hydroxy-(9Cl) and was Michelman MICHEM® 72040 emulsion. The mixture was mechanically stirred, at a low speed to avoid foaming, for 45 minutes.

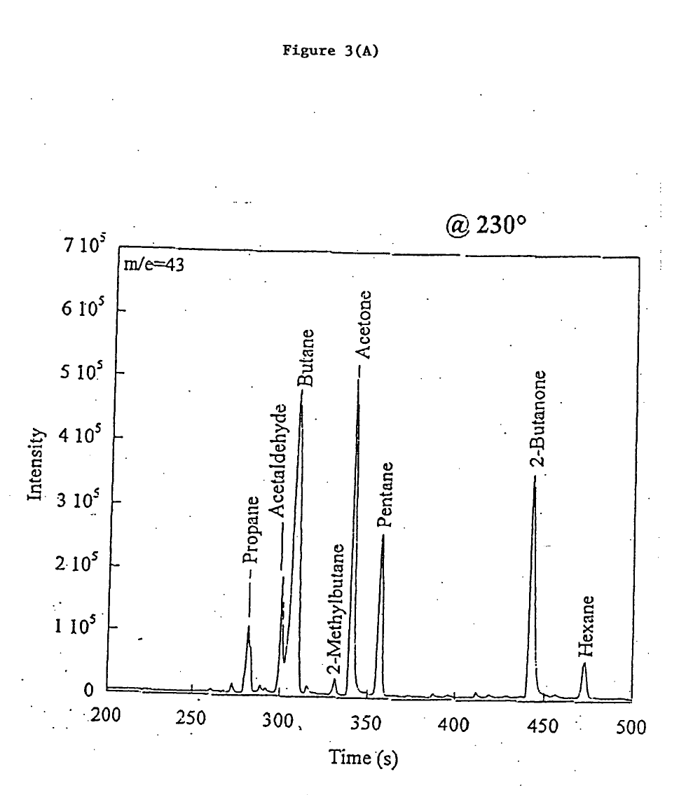

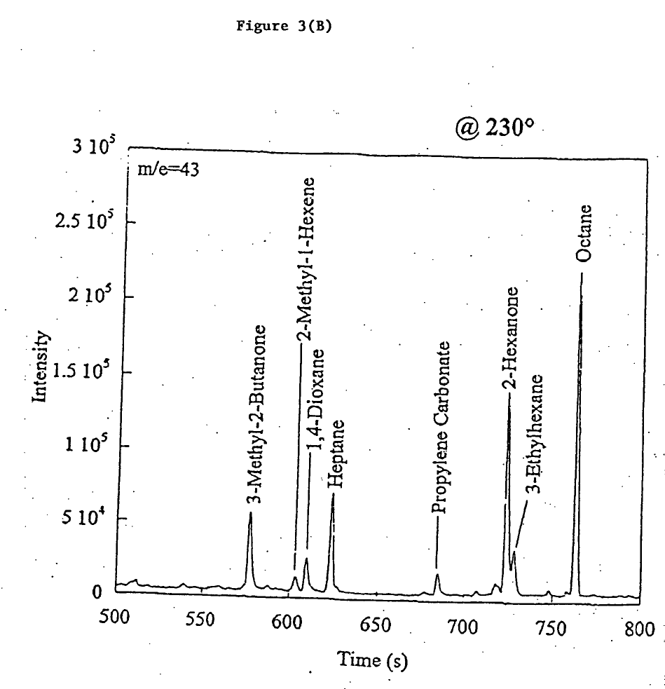

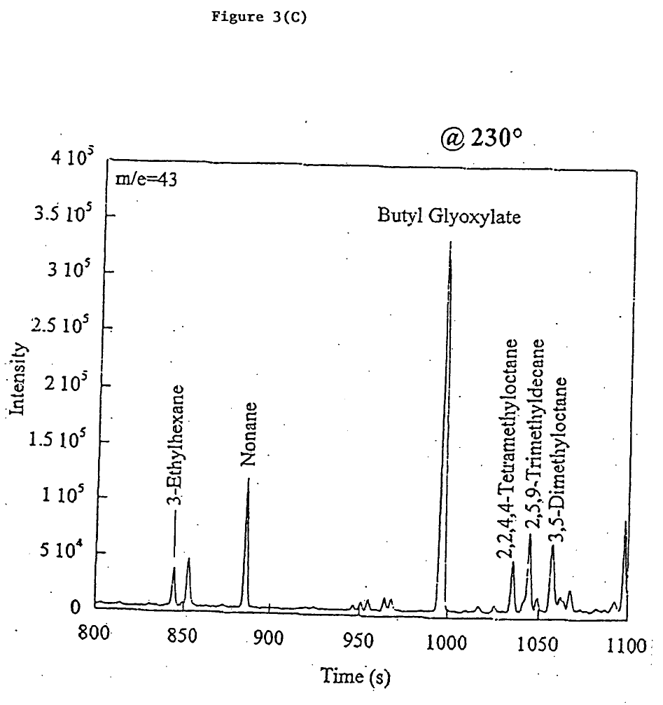

The slurry was added to the feed port of a 350° C. pre-heated NIRO rotating-disc type spray drier by peristaltic pump, and was not stirred further once the addition began. The drier inlet temperature was maintained at 350° C. and the outlet temperature at 110° C. for the duration of the 80 minute run. The disc was rotated by air pressure maintained at a setting of 2 on the unit. The water evaporates during the spray drying. A total of 581 grams of dry product was collected. The organic portion was determined by thermal analysis to constitute 29.9% of the product, and had a melting point of 106° C. A GCMS of the Inventive Example 1 masterbatch precursor is shown in FIG. 3. The results show the presence of the surfactant.

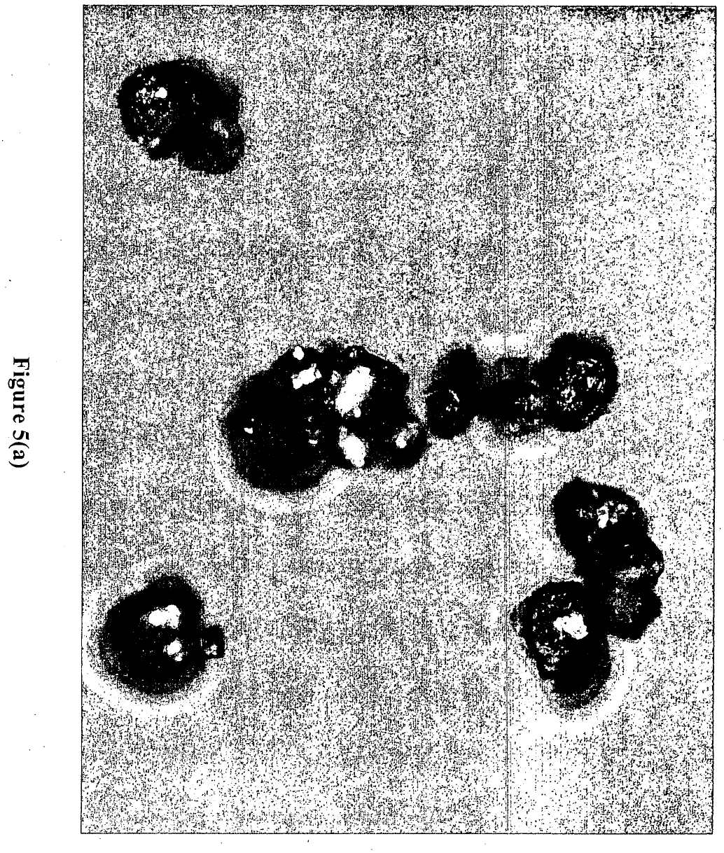

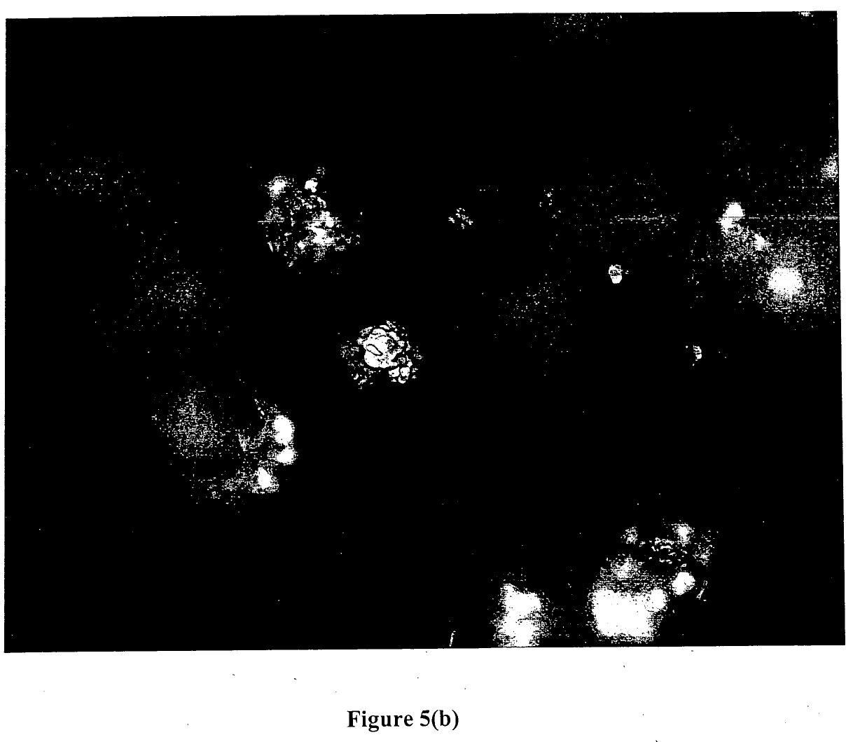

A product prepared similar to that of the process of Inventive Example 1 was subjected to optical microscopy. Optical microscopy revealed that almost all of the resulting product was spherical as shown in FIG. 5(a) at 200× magnification and FIG. 5(b) at 500× magnification. The average particle size diameter was from about 8 to about 120 microns with most of the particles having an average particle size diameter from about 24 to about 60 microns.

### INVENTIVE EXAMPLE 2

Inventive Example 1 above was repeated except that only 1050 grams of water were used for the slurry. 620 grams of dry product were collected.

The products from Inventive Examples 1 and 2, and Comparative A pigment were each sieved through a series of 7 screens ranging from 20 mesh through 325 mesh. The percentage of each sample falling within the stated particle sizes is presented in the following data table. The Inventive Example 2 product was observed to possess a narrower distribution of particle sizes. The particle sizes are in microns. The data entries in the following Table 1 are the percent of sample in the range.

TABLE 1
Particle Size Distributions from Screening Analysis.

| | Sample | | | | | | | |
|---|---|---|---|---|---|---|---|---|
| | | 150- | 125- | 106- | 90- | | | |
| | 850 | 850 | 150 | 125 | 106 | 75-90 | 45-75 | 45 |
| Comp A | 11.3 | 59.8 | 6.4 | 4.9 | 4.4 | 3.9 | 6.6 | 2.7 |
| Ex. 2 | 1.2 | 63.4 | 20.8 | 12.1 | 2.2 | 0.1 | 0.03 | 0.01 |
| Ex 1 | 0.0 | 36.4 | 12.1 | 9.8 | 8.9 | 8.2 | 15.9 | 8.5 |

### COMPARATIVE E

Inventive Example 2 above was repeated except that only 438 grams of the polyethylene emulsion were used, yielding a theoretical wax content of 20.0% in the product.

### INVENTIVE EXAMPLE 3

Inventive Example 2 above was repeated except that Michelman MICHEM® 72040M emulsion was used instead of Michelman MICHEMO® 72040 emulsion. A DSC of Inventive Example 3 is shown in FIG. 2.

### INVENTIVE EXAMPLE 4

Inventive Example 2 above was repeated except that Michelman MICHEM® 72040M1 emulsion was used instead of Michelman MICHEMO® 72040 emulsion. A DSC of Inventive Example 4 is shown in FIG. 2.

### INVENTIVE EXAMPLE 5

A 30 horsepower 250 gallon Cowles dissolver was used. In Batch 1, the pigment used was MAGNAPEARLO® 2100 pigment from Engelhard Corporation and comprised 56.5-64.5 weight percent mica, 0.2-2.0 weight percent tin oxide, and 35.5-41.5 weight percent titanium dioxide. The pigment was added to deionized water in the Cowles tank with the mixer energized. The emulsion's solid content comprised about 96.3 percent by weight oxidized polyethylene wax and 3.7 percent by weight C12 to C14 secondary alcohol ethoxylate and was Michelman MICHEM® 72040M1 emulsion. The emulsion was added to the mica slurry. Because the mica slurry was extremely viscous prior to adding the emulsion, Batches 2 and 3 added the emulsion to the water before adding the mica slurry. The percentages of components used are in Table 2 below.

TABLE 2

| | PEARLESCENT | | DEIONIZED |
|---|---|---|---|
| BATCH | PIGMENT (kg) | EMULSION (kg) | WATER (gallons) |
| 1 | 292 | 313 | 115 |
| 2 | 219 | 234 | 86 |
| 3 | 266 | 285 | 105 |
| TOTAL | 777 | 832 | 306 |

The Cowles tank was pumped to a 125 gallon unagitated dryer feed tank using an air diaphragm pump. The dryer atomizer was fed with a peristaltic pump. Drying was done on a Niro 12 ft. dryer. The water evaporates during spray drying. Target temperatures were 400° F. on the inlet and 205° F. on the outlet. After the 250 gallon batches emptied to the 125 gallon dryer feed tank, new batches were made. This procedure enabled the drying process to continue without interruption. No changes were made in target drying conditions throughout the run. The dry product was caught in 55 gallon steel drums fitted with plastic liners.

The run produced 1,063 kilograms of free flowing powder. This was a theoretical yield of 96% of materials introduced to batches. Total drying time was nine hours. Average production rate was 260 pounds/hour and average water evaporation rate was 389 pounds/hour.

The following Comparatives and Inventive Examples are directed to masterbatches and preparation thereof.

### Inventive Example 6 and Comparatives F and G

Using a Leistritz AG type LSM 34 GG extruder equipped with twin 34 millimeter counter-rotating 24:1 L/D, PVC type screws, the product of Comparative A above or Comparative E above or Inventive Example 2 above was extruded into low density polyethylene (“LDPE”) resin to prepare 25% pigment masterbatches. 4.5 kilograms of the masterbatch precursor was used. Thus, the masterbatch precursor contained 1.61 kilograms of Comparative A or Comparative E or Inventive Example 2 and 2.89 kilograms of LDPE resin. The masterbatch precursor also contained 45 grams of Witco mineral oil.

The extruder was operated at a constant screw speed of 200 revolutions per minute (RPM), a constant screw torque of 12 amps, and was starve-fed with the pre-mixed blend of masterbatch precursor and LDPE resin. The throughput rate of the extruded product was calculated, and the number of strand breakages during the approximately 45 minute runs was recorded. The back pressure inside the extruder as well as the extruder die temperature were also recorded for each run (or run segment if it changed significantly within the run). The throughput and strand breakage results for the relevant experiments is presented in the following Table 3 where masterbatch is abbreviated as MB, Comparative is abbreviated as Comp., and Inventive Example is abbreviated as Inv. Ex.

TABLE 3
Masterbatch Throughput and
Strand Breakage vs. Extruder Die Temperature

| Inv. Ex. | | | Wax melting | | Die | No. Of | MB |
|---|---|---|---|---|---|---|---|
| Or | Run | MB | point | | Temp. | Strand | Throughput |
| Comp. | No. | Precursor | (° C.) | Wax % | (° C.) | Breaks | Rate, g/min. |
| Comp. F | 1 | Comp. A | 108 | 30 | 253 | Several | 98.7 |
| Comp. F | 1 | Comp. A | 108 | 30 | 244 | 0 | 108.6 |
| Comp. F | 1 | Comp. A | 108 | 30 | 239 | 0 | 107.6 |
| Inv. Ex. 6 | 2 | Inv. Ex. 2 | 106 | 29.9 | 220 | 0 | 158.4 |
| Inv. Ex. 6 | 2 | Inv. Ex. 2 | 106 | 29.9 | 230 | 0 | 160.6 |
| Inv. Ex. 6 | 2 | Inv. Ex. 2 | 106 | 29.9 | 224 | 0 | 155.6 |
| Comp. G | 3 | Comp. E | 106 | 20 | 211 | 0 | 88.7 |
| Comp. G | 3 | Comp. E | 106 | 20 | 151 | 0 | 89.6 |
| Comp. G | 3 | Comp. E | 106 | 20 | 146 | 0 | 82.3 |
| Comp. F | 4 | Comp. A | 108 | 30 | 180 | 12 | 108.6 |
| Inv. Ex. 6 | 5 | Inv. Ex. 2 | 106 | 29.9 | 165 | 0 | 119.9 |
| Inv. Ex. 6 | 5 | Inv. Ex. 2 | 106 | 29.9 | 175 | 0 | 122.0 |
| Inv. Ex. 6 | 5 | Inv. Ex. 2 | 106 | 29.9 | 180 | 0 | 138.7 |

Throughput is the mass per unit time of the produced extrudate. The results show that using the Inventive Example 2 masterbatch precursor advantageously in Inventive Example 6 masterbatch provided a higher throughput rate than using the Comparative A masterbatch precursor in Comparative F masterbatch. Also, the Comparative F masterbatch broke which disadvantageously required a manual feed from the extruder to the chopper. We believe that such strand breakage is due to non-homogeneous masterbatch. It was unexpectedly found that a direct relationship exists between the extruder die temperature and the throughput for the Inventive Example 6 masterbatch. However, no such relationship was observed for Comparative F masterbatch over the extruder die temperature range of 165° C. to 253° C.

The results also show the criticality of having greater than 20 percent by weight of wax (Inventive Example 6) compared with 20 percent by weight of wax (Comparative G) in order to provide higher extruder throughput rate.

### COMPARATIVE H

Using the extruder as described in Inventive Example 6 above, the masterbatch precursor of Comparative B above was fed into LDPE to prepare a 25% pigment masterbatch. The extruder was operated at conditions similar to those of Inventive Example 6 above. No strand breaks occurred in the 25% pigment masterbatch, and the 3, 15 minute throughput rates were 58.5, 71.4, and 70.1 grams/minute.

These results show that the Inventive Example 6 masterbatch advantageously provided a higher throughput rate as set forth in Table 2 above than the Comparative H masterbatch and thus, demonstrates the surprising result achieved by the present invention having surfactant therein.

### COMPARATIVE I

Using the extruder as described in Inventive Example 6 above, the masterbatch precursor of Comparative C above was fed into LDPE to prepare a 25% pigment masterbatch. The extruder was operated at a lower temperature range of 160° to 175° C. and a back pressure range of 60 to 110 psi. The amperage to the screw could not be maintained at the desired 12.0 amps, but instead reached a maximum of 10.5 amps as a consequence of necessarily lowering the feed rate to alleviate premature wax melting in the feed throat area of the extruder. The 25% pigment masterbatch suffered multiple strand breaks, and throughput rates were calculated at 100.4, 102.5, and 100.7 grams/minute.

These results show that the Inventive Example 6 masterbatch advantageously provided a higher throughput rate as set forth in Table 3 above than the Comparative I masterbatch and thus, demonstrates the surprising result achieved by the present invention having surfactant therein. Also, the Inventive Example 6 masterbatch did not break while the Comparative I masterbatch did.

### COMPARATIVE J

Using the extruder as described in Inventive Example 6 above, the masterbatch product of Comparative D above was fed into LDPE to prepare a 25% pigment masterbatch. The extruder was operated at 166 to 206° C. At least 10 strand breaks were recorded for the 25% pigment masterbatch and throughput rates in three successive periods were calculated at 104.9, 96.3, and 88.8 grams/minute.

These results show that the Inventive Example 6 masterbatch advantageously provided a higher throughput rate as set forth in Table 3 above than the Comparative J masterbatch and thus, demonstrates the surprising result achieved by the present invention having surfactant. Also, the Inventive Example 6 masterbatch did not break while Comparative J masterbatch did.

### INVENTIVE EXAMPLE 7

Using the extruder as described in Inventive Example 6 above, the Inventive Example 3 masterbatch product was extruded into LDPE resin to prepare 25% pigment masterbatch.

### INVENTIVE EXAMPLE 8

Using the extruder as described in Inventive Example 6 above, the Inventive Example 4 masterbatch product was extruded into LDPE resin to prepare 25% pigment masterbatch.

### INVENTIVE EXAMPLE 9

Using an extruder similar to that described in Inventive Example 6 above, the Inventive Example 1 masterbatch precursor was fed into polypropylene to prepare a 43.5% pigment masterbatch. 3.1 kilograms of masterbatch were produced in 3.5 minutes.

### INVENTIVE EXAMPLE 10

Using an extruder similar to that described in Inventive Example 6 above, the Inventive Example 1 masterbatch precursor was fed into polystyrene to prepare a 43.5% pigment masterbatch. 1.25 kilograms of masterbatch were produced in 2 minutes.

### INVENTIVE EXAMPLE 11

Using the extruder as described in Inventive Example 6 above, the masterbatch precursor of Inventive Example 5 above was fed into LDPE to prepare a 25% pigment masterbatch. The masterbatch precursor contained 1.61 kilograms of Inventive Example 5 and 2.89 kilograms of LDPE resin. The masterbatch precursor also contained 45 grams of Witco mineral oil. The extruder conditions are in the following Table 4 and the throughput data are in the following Table 5.

TABLE 4

| | | | | Amps | |
|---|---|---|---|---|---|
| | Back | Die | Screw | To | |
| Time | Pressure | Temperature | Speed | Extruder | Strand |
| (Minutes) | (psi) | (° C.) | (rpm) | Screw | Breakage |
| 0 | 230 | 145 | 200 | 12.5 | None |
| 4 | 220 | 148 | 200 | 12.0 | None |
| 9 | 200 | 152 | 200 | 12.5 | None |
| 24 | 160 | 173 | 200 | 12.0 | None |
| 27 | 120 | 180 | 200 | 12.5 | None |
| 34 | 160 | 185 | 200 | 12.5 | None |

TABLE 5

| | | | Throughput |
|---|---|---|---|
| | Time | Sample Mass | Rate |
| Period No. | (Minutes) | (grams) | (grams/minute) |
| 1 | 10 | 1464.0 | 146.4 |
| 2 | 15 | 2386.0 | 159.1 |
| 3 | 15 | 2897.8 | 193.2 |

The results show that using the Inventive Example 5 masterbatch precursor advantageously in Inventive Example 11 masterbatch provided a higher throughput rate than using the Comparative A masterbatch precursor in Comparative F masterbatch. Also, the Comparative F masterbatch broke which disadvantageously required a manual feed from the extruder to the chopper. We believe that such strand breakage is due to non-homogeneous masterbatch. It was unexpectedly found that a direct relationship exists between the extruder die temperature and the throughput rate for the Inventive Example 11 masterbatch.

### INVENTIVE EXAMPLE 12

Using the extruder as described in Inventive Example 6 above, the masterbatch precursor of Inventive Example 5 above was fed into LDPE to prepare a 35% pigment masterbatch. The masterbatch precursor contained 0.750 kilogram of Inventive Example 5 and 0.750 kilogram of LDPE resin. The masterbatch precursor also contained 15 grams of Witco mineral oil. The extruder conditions are in the following Table 6 and the throughput data are in the following Table 7.

TABLE 6

| | Back | Die | Screw | Amps To | |
|---|---|---|---|---|---|
| Time | Pressure | Temperature | Speed | Extruder | Strand |
| (minutes) | (psi) | (° C.) | (rpm) | Screw | Breakage |
| 2 | 180 | 179 | 200 | 11.5 | |
| 5 | — | — | — | 10.0 | |
| 0 | 170 | 193 | 200 | 12.0 | |
| 2 | 180 | 195 | 200 | 12.5 | |
| 5 | 190 | 204 | 200 | 12.5 | 2 strand |
| | | | | | breaks |
| | | | | | occurred at |
| | | | | | >200° C. |

TABLE 7

| | | | Throughput |
|---|---|---|---|
| | Time | Sample Mass | Rate |
| Period No. | (Minutes) | (Grams) | (Grams/Minute) |
| 1 | 5.13 | 936.4 | 182.5 |
| 2 | 5 | 1224 | 244.8 |

In Table 6 above, the strand breaks occurred due to the overflow of the second feed port with molten mix. No strand breaks occurred prior to this. According to the extruder operator, the maximum practical throughput rate was exceeded.

### COMPARATIVE K

Using the extruder as described in Inventive Example 6 above, the masterbatch precursor of Comparative A above was fed into LDPE to prepare a 35 % pigment masterbatch. 23 strand breakages occurred and thus, this composition was unusable.

### INVENTIVE EXAMPLE 13 and COMPARATIVE L

The product of Inventive Example 5 was used for Inventive Example 13 while Comparative A was used as the starting material for Comparative L. The extruder was a 50 mm corotating twin screw extruder. The feed was from a vertical twin screw tank. Extrudate was formed in ten, 3 mm strands. Extrudate was cooled in a 15 ft. water bath then dried by two air dryers in series. The extrudate strands are then fed into an approximately 30hp pelletizer. Material is screened to remove fines after pelletizing. Polyethylene resin powder was used. Zone temps (C) for all eleven zones were 150. Die temp was 175. The results are in Table 8 below.

TABLE 8

| | Output | Torque (% | Bulk density | Screw |
|---|---|---|---|---|
| Sample | (lbs/hr) | of max) | extrudate (lb/ft³) | RPM |
| Inventive | 720 | 64 | 43 | 1200 |
| Example 13 | | | | |
| Comparative L | 600 | 60 | 41 | 1000 |

| | | | Melt | | |
|---|---|---|---|---|---|
| Sample | Pellets/Gram | Ash | Index | % H₂O | Dispersion |
| Inventive | 45 | 26.9 | 15.9 | 0.00 | Pass |
| Example 13 | | | | | |
| Comparative L | 43 | 26.9 | 22.0 | 0.00 | Pass |

1. A substantially spherical composition comprising:
(a) about 60 to about 80 weight percent pearlescent pigment;
(b) about 14 to about 38 weight percent wax; and about 2 to about 6 weight percent surfactant.

2. The substantially spherical composition of claim 1 wherein said wax (b) has dispersive groups.

3. The substantially spherical composition of claim 1 wherein said wax (b) is oxidized.

4. The substantially spherical composition of claim 3 wherein said oxidized wax is oxidized hydrocarbon.

5. The substantially spherical composition of claim 4 wherein oxidized hydrocarbon is oxidized polyolefin.

6. The substantially spherical composition of claim 5 wherein said oxidized polyolefin is oxidized polyethylene or oxidized polypropylene

7. The substantially spherical composition of claim 1 wherein said surfactant (c) has polar and non-polar portions.

8. The substantially spherical composition of claim 1 wherein said surfactant (c) is selected from the group consisting of poly(oxy-1,2-ethanediyl),α(9Z)-9-octadecenyl-ω-hydroxy-(9Cl) and a mixture of C12-14 secondary ethoxylated alcohols.

9. A masterbatch precursor comprising said substantially spherical composition of claim 1.

10. A masterbatch comprising polymer and said masterbatch precursor of claim 9.

11. The masterbatch of claim 10 wherein said masterbatch precursor is present in an amount sufficient to prepare a masterbatch of at least 25 weight percent pearlescent pigment.

12. A method of making the composition of claim 1 comprising the steps of:
combining pearlescent pigment and emulsion comprising wax, surfactant, and water; and
spray drying said combination to form said substantially spherical composition.

13. A method of increasing throughput rate in an extruder comprising the steps of:
(a) combining polymer and substantially spherical composition comprising pearlescent pigment, wax, and surfactant; and
(b) extruding said combination to form a masterbatch.

14. The method of claim 13 wherein said wax (b) has dispersive groups.

15. The method of claim 13 wherein said wax (b) is oxidized.

16. The method of claim 15 wherein said oxidized wax is oxidized hydrocarbon.

17. The method of claim 16 wherein oxidized hydrocarbon is oxidized polyolefin.

18. The method of claim 17 wherein said oxidized polyolefin is oxidized polyethylene or oxidized polypropylene.

19. The method of claim 13 wherein said surfactant (c) has polar and non-polar portions.

20. The method of claim 13 wherein said surfactant (c) is selected from the group consisting of poly(oxy-1,2-ethanediyl),α-(9Z)-9-octadecenyl-ω-hydroxy-(9Cl) and a mixture of C12-14 secondary ethoxylated alcohols.
